(19) United States
(12) Patent Application Publication
(10) Pub. No.: US 2016/0073360 A1
(43) Pub. Date: Mar. 10, 2016

(54) RADIO COMMUNICATION SYSTEM AND MOBILE TERMINAL DEVICE

(71) Applicant: NTT DOCOMO, INC., Tokyo (JP)

(72) Inventors: Tooru Uchino, Tokyo (JP); Hideaki Takahashi, Tokyo (JP)

(73) Assignee: NTT DOCOMO, INC., Tokyo (JP)

(21) Appl. No.: 14/784,046

(22) PCT Filed: Apr. 28, 2014
(86) PCT No.: PCT/JP2014/061875

§ 371 Date: Oct. 13, 2015

(30) Foreign Application Priority Data
May 29, 2013 (JP) 2013-113386

(51) Int. Cl. H04W 52/36; H04W 24/10; H04W 72/04

(52) U.S. Cl. CPC H04W 52/365; H04W 72/0413; H04W 24/10

(57) ABSTRACT

A radio communication system includes a radio base station and a mobile terminal device communicating with the radio base station using carrier aggregation, wherein upon occurrence of a triggering event of sending a power headroom report to the radio base station, the mobile terminal device is configured to determine whether there is a secondary cell that is in the process of activation, and wherein the mobile terminal device is configured to suspend transmission of the power headroom report to the base station for a predetermined time period if there is a secondary cell that is in the process of activation.

### TECHNICAL FIELD

The present invention relates to a radio communication technology, and more particularly, to transmission timing control on an uplink power headroom report sent from a mobile terminal device.

### BACKGROUND ART

Long term evolution standardization in Third Generation Partnership Project (which may be referred to as “3GPP LTE”) Release 10, Release 11, and the subsequent ones provide “LTE-advanced”, which technology further evolves and enhances LTE standard.

As illustrated in FIG. 1, part (A), an uplink (UL) scheduler of a radio base station 20, which is also called an evolved Node B (eNB) 20, selects a transport format of a physical uplink shared channel (PUSCH) every transmission time interval (TTI) for each user equipment (UE) 100.

A feedback mechanism of sending a power headroom report (PHR) from the UE 100 to the eNB 20 is employed such that the UL scheduler of the eNB 20 can select an appropriate PUSCH transport format. See, for example, the non-patent document listed below.

Power headroom (PH) represents remaining or surplus power estimated by subtracting PUSCH transmission power from the maximum transmission power of UE 100 on a certain component carrier. The greater the PH value, the more room in uplink transmission from the UE 100. In this case, the eNB 20 selects a modulation scheme with a higher transmission bit rate and allocates more uplink resources.

Meanwhile, carrier aggregation (CA) is being put into practical use. Carrier aggregation allows mobile broadband communication by bundling two or more component carriers. Each component carrier corresponds to a unit frequency block. In carrier aggregation, the UE 100 is connected to a primary cell (PCell), which cell is reliable for securing connectivity, and is further connected to a secondary cell (SCell). The SCell is configured at the UE 100, in addition to the PCell. Adding and deletion of the Scell is controlled by configuration at the Radio Resource Control (RRC) protocol layer. Immediately after configuration of a SCell at the UE 100 by RRC configuration, the SCell is in the deactivated state. Upon having been activated at the Medium Access Control (MAC) layer, the SCell enters the operable or schedulable state.

### LIST OF PRIOR ART DOCUMENTS

Non-patent Document 1: 3GPP TS36.321, V10.8.0, Evolved Universal Terrestrial Radio Access (E-UTRA); Medium Access Control (MAC) protocol specification

### SUMMARY OF THE INVENTION

### Technical Problem to be Solved

As illustrated in FIG. 1, part (B), the UE 100 receives an activation command for SCells with configured uplinks from the eNB 20. Upon receiving the activation command, the UE 100 sends a PHR of the activated SCells (or the SCells which have already been in the activated state). Depending on the implementation of the UE 100, the amount of time required for completion of SCell activation may vary among the SCells. In this case, PHR may be sent several times.

For example, UE 100 receives an activation command for SCell #1 and SCell #2 from the eNB 20. When SCell #1 is activated first, a PCell PHR and a PHR of SCell #1 are sent at time T1. Then, upon activation of SCell #2 at time T2, a PCell PHR and a PHR of SCell #2 are sent at time T2. This system arrangement has a problem of increased overhead.

In view of the problem, it is one of objectives of the present invention to provide a radio communication system and a mobile terminal device that are capable of controlling PHR transmission timing and reducing overhead.

### Means for Solving the Problem

To achieve the objective, in one aspect of the invention, a radio communication system includes a radio base station and a mobile terminal device communicating with the radio base station using carrier aggregation,

wherein upon occurrence of a triggering event of sending a power headroom report to the radio base station, the mobile terminal device is configured to determine whether there is a secondary cell that is in the process of activation, and

wherein the mobile terminal device is configured to suspend transmission of the power headroom report to the base station for a predetermined time period if there is a secondary cell that is in the process of activation.

In another aspect of the invention, a mobile terminal device has

a trigger event detector configured to monitor whether transmission of a power headroom report has been triggered,

a PHR creator configured to create a power headroom report upon detection of triggering of the power headroom report,

a secondary cell state manager configured to determine whether there is a secondary cell that is in the process of activation when the power headroom report is triggered, and

a transmission timing controller configured to suspend transmission of the power headroom report if there is a secondary cell that is in the process of activation at the time of the triggering of the power headroom report.

### Advantageous Effect of the Invention

PHP transmission timing can be controlled at the mobile terminal device and uplink overhead can be reduced.

### BRIEF DESCRIPTION OF THE DRAWINGS

FIG. 1 is a diagram explaining a problem arising in PHR transmission;

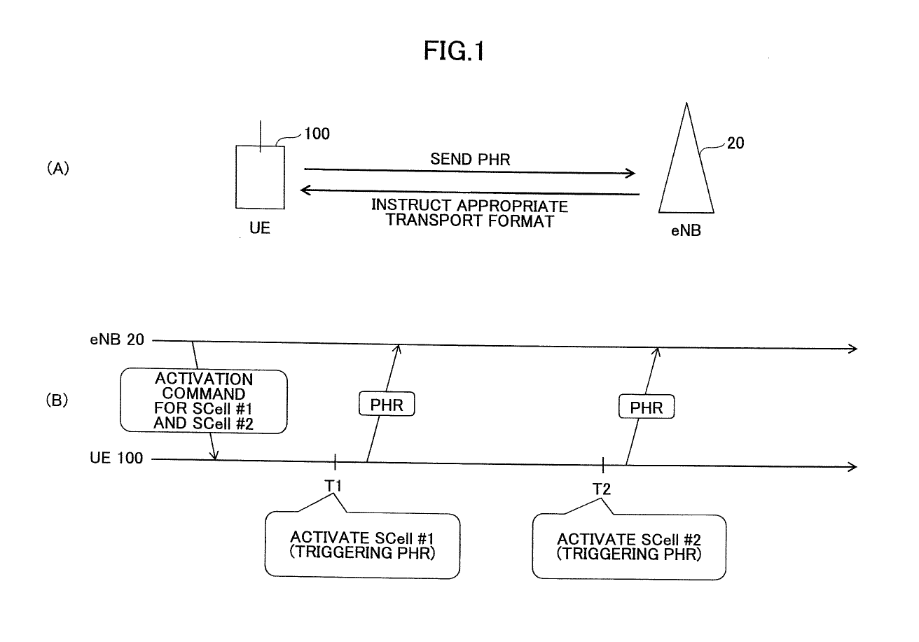

FIG. 2 is a diagram illustrating a PHR transmission timing control scheme in a radio communication system according to the first embodiment of the invention;

FIG. 3 is a diagram illustrating scenes where carrier aggregation is performed;

FIG. 4 is a flowchart illustrating a PHR transmission timing control flow according to the first embodiment;

FIG. 5 is a diagram illustrating a PHR transmission timing control scheme according to the second embodiment;

FIG. 6 is a flowchart illustrating a PHR transmission timing control flow according to the second embodiment;

FIG. 7 is a schematic diagram of user equipment according to the embodiments; and

FIG. 8 illustrates an example of PHR format.

### EMBODIMENTS TO CARRY OUT THE INVENTION

### First Embodiment

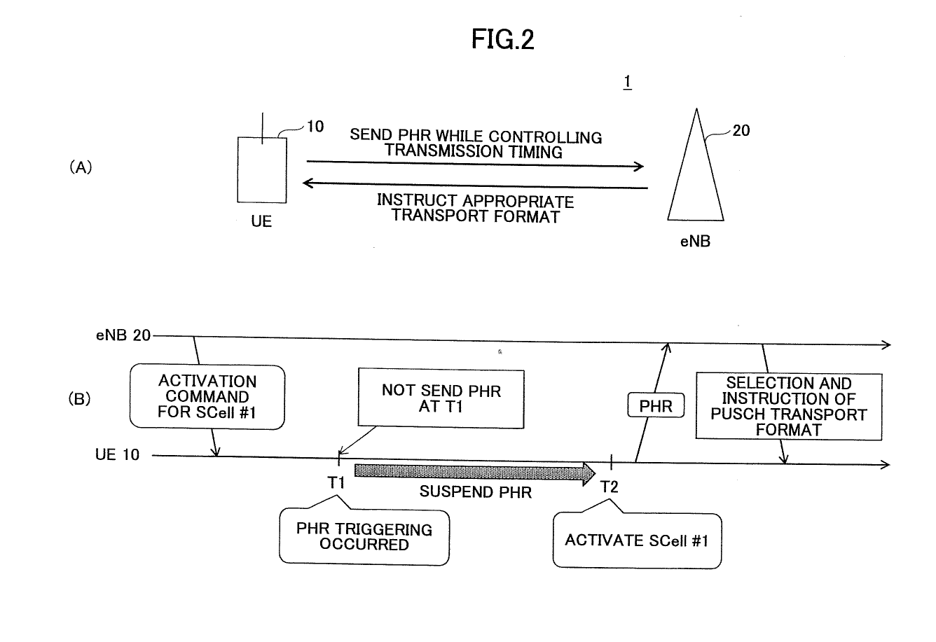

FIG. 2 is a diagram illustrating a PHR transmission timing control scheme in a radio communication system 1 according to the first embodiment. As illustrated in FIG. 2, part (A), the radio communication system 1 includes a mobile terminal device 10 and a radio base station 20. In the embodiments, the mobile terminal device 10 is called “user equipment (UE) 10”, and the radio base station 20 is called “eNB 20”.

The UE 10 controls power headroom report (PHR) transmission timing and prevents uplink overhead from increasing. The eNB 20 receives a PHR, and based upon the received PHR, it selects the optimum PUSCH transport format for the UE 10 for every component carrier reported in the PHR. The eNB 20 informs the UE 10 of the selected PUSCH transport format over a physical downlink control channel (PDCCH). The PUSCH transport format may be indicated in an uplink resource indicator (such as an UL grant) allocated to the UE 10.

At the UE 10, PHR transmission may be triggered at following timings.
(a) Under the condition that the PHR prohibit timer has expired, a pass loss has changed beyond a threshold with respect to the pass loss at the latest PHR transmission and a new uplink transmission is available.
(b) Periodic PHR timer has expired.
(c) The PHR function is turned on.
(d) A SCell with a configured uplink is activated.
(e) Under the condition that the PHR prohibit timer has expired, new uplink transmission is available, transmission of PUSCH or physical uplink control channel (PUCCH) is available, and power back-off has changed over a threshold with respect to the power back-off at the time of the latest PHR transmission.

In the first embodiment, a PHR is not necessarily sent every time a PHR triggering event has occurred. Rather, a PHR is suspended from being transmitted until a predetermined time period passes from the PHR triggering, if there is a SCell that is in the process of activation at the time of the PHR triggering. This arrangement is provided in order to absorb time required for SCell activation and reduce overhead.

A more particular explanation is made of this control scheme, referring to FIG. 2, part (B). A PHR triggering condition is satisfied at time T1. For example, a path loss has changed over a predetermined (threshold) range since the latest PHR transmission in a PCell, or in other SCells with configured uplinks for the UE 10.

In this situation, according to a conventional scheme, a PHR is sent at time T1. In contrast, in the first embodiment, the UE 10 suspends transmission of a PHR at time T1 if there is a SCell (e.g., SCell #1) that is in the process of activation at T1. If SCell #1 becomes active at time T2 before a predetermined time period passes from T1, a PHR is sent upon complete activation of the SCell #1. This PHR contains PH information of the activated SCell #1, PH information items of the PCell, and PH information items of other SCell(s) with configured uplink(s).

The “predetermined time period” may be a fixed time period set in a timer of the UE 10, or it may be instructed from eNB 20. Alternatively, a variable time period may be used, such as “a time period that continues until completion of activation of SCell #1 is detected within the TTI”. As still another alternative, the PHR transmission timing control function of UE 10 itself may be ON/OFF controlled by MAC/RRC signaling from the eNB 20. The “predetermined time period” may vary among SCells, or the predetermined time period may be set in advance for each combination of a PHR-triggered SCell by means of activation and a SCell that is in the process of activation.

By monitoring the activation states of SCells at the UE 10, the UE 10 can control PHR transmission timing by itself. Consequently, uplink overhead can be reduced.

A PHR contains, for example, the maximum transmit power P_{CMAX,c}(i) of component carrier c(i) over which the UE 10 is connected to the cell, and a power headroom PHc(i). There are two types of PHR sending formats, i.e., Type 1 and Type 2. Type 1 is used when only PUSCH can be transmitted by the UE 10 at a certain sub-frame. Type 2 is used when PUSCH and PUCCH can be simultaneously transmitted by the UE 10 at a certain sub-frame.

In Type 1, power headroom (PH) is expressed by Formula (1).

PH_{type1,c}(i)=P_{CMAX,c}(i)−

{10 log₁₀(M_{PUSCH,c}(i))+P_{O}_{_{—}}_{PUSCH,c}(j)+α_{c}(j)·PL_{c}+Δ_{TF,c}(i)+f_{c}(i)} (1)

where P_{CMAX,c}(i) of the first term of the right hand side of Formula (1) denotes the maximum transmit power of the component carrier c(i) allocated to the UE 10, taking necessary power back-off into account. The second term of the right hand side of Formula (1) denotes a transmit power of PUSCH without considering power sticking due to P_{CMAX,c}(i). M_{PUSCH,c}(i) denotes the number of resource blocks, P_{O}_{_{—}}_{PUSCH},c(i) denotes the reference power offset (which is a broadcast parameter), αc(j) denotes the slope of Fraction TPC for controlling a target value of transmit power control (which is also a broadcast parameter), PLc denotes path loss, Δ_{TF},c(i) denotes power offset based upon the modulation scheme and coding rate, and fc(i) denotes closed loop power control correction value.

The reporting format of PHR may employ either Type 1 or Type 2. Only a power headroom (PH) may be sent without reporting P_{CMAX,c}(i).

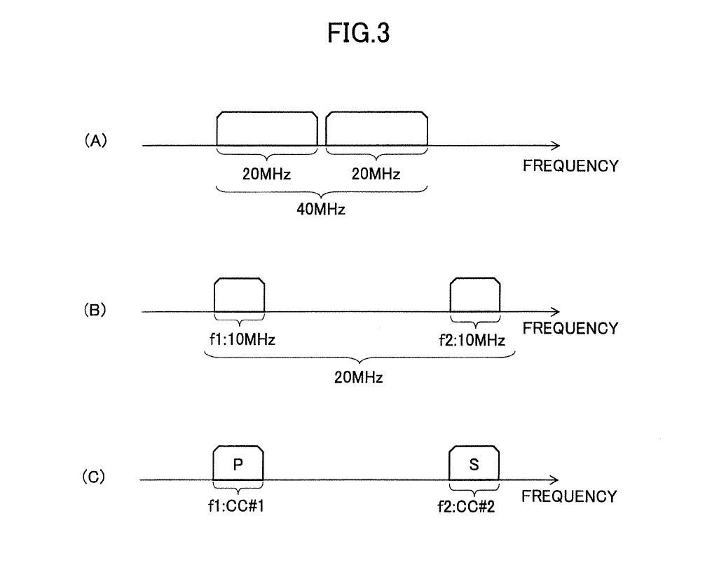

While carrier aggregation is performed, the UE 10 sends PHR for each component carrier. FIG. 3 illustrates several scenes where carrier aggregation is performed. In part (A) of FIG. 3, carrier aggregation allows broadband communication over 20 MHz, while maintaining backward compatibility with the previous connection state. In part (B) of FIG. 3, when a continuous frequency band cannot be secured for necessary bandwidth (e.g., 20 MHz), carrier aggregation is carried out.

Under these scenarios, the UE 10 may be connected to a PCell using component carrier (CC #1) of frequency f1 to guarantee the connectivity with the network, and connected to a SCell using component carrier (CC #2) of frequency f2 from a separated band of CC #1.

Returning to FIG. 2, part (B), when the UE 10 receives an activation command for SCell #1 from eNB 20, the SCell #1 is configured at the RRC layer. Scheduling is not to be available until the SCell #1 is activated at the MAC layer. If a PHR triggering condition (e.g., any one of the conditions (a) through (e) described above) is satisfied after receiving the activation command for SCell #1 and before completion of activation, the UE 10 suspends PHR from being sent for a predetermined time period because the SCell #1 is still in the process of activation. When the predetermined time period has passed from time T1 (i.e., the occurrence of the PHR triggering event), or when activation is completed before the expiration of the predetermined time period, then a PHR that contains PH information items of PCell, other SCell(s) with configured uplink, and the newly activated SCell #1 is sent to the eNB 20.

If activation of SCell #1 is not completed within the predetermine time period, then a PHR containing only the PH information item of the PCell and the PH information item of the already connected other SCell is sent upon expiration of the predetermined time period. When the SCell #1 is completely activated after the expiration of the predetermined time period, then the PH information item of the SCell #1 may be sent together with the PH information items of the PCell and the other SCell. In this case, it is likely that the next scheduling timing (TTI) has visited timely.

Upon receiving the PHR, the eNB 20 selects a PUSCH transport format for each component carrier such that the PUSCH transmit power of the UE 10 becomes at or below P_{CMAX,c}. The UE 10 is informed of the selected transport format by UL grant. The transport format includes a modulation scheme, a coding rate, and the number of resource blocks. A transport block size (TBS) is uniquely determined from the modulation scheme, the coding rate, and the number of resource blocks. The eNB 20 estimates a path loss between itself and the UE 10. If the path loss is small, a modulation scheme and a coding rate are selected so as to increase the TBS. Consequently, block error rate (BLER) is maintained constant regardless of the degree of path loss.

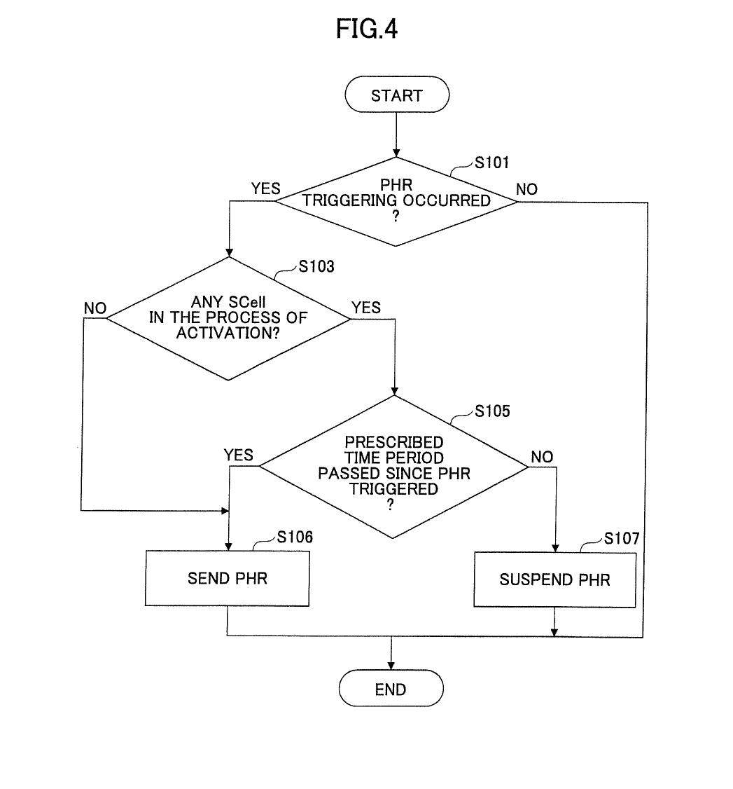

FIG. 4 is a flowchart of PHR transmission timing control performed by the UE 10 according to the first embodiment. The control flow of FIG. 4 may be performed, for example, every TTI that is the minimum unit time for scheduling.

First, it is determined at the UE 10 whether PHR triggering has occurred (S101). PHR may be triggered when any one of the conditions (a) through (e) described above is satisfied, or when a newly defined PHR triggering condition (which may be provided in the future) is satisfied.

If a PHR triggering event has occurred (YES in S101), it is determined whether there is a SCell that is in the process of activation by determining, for example, whether an activation command for a deactivated SCell has been received (S103). If there is no SCell in the process of activation (NO in S103), then the PHR is sent in an ordinary process (S106). In this case, that PHR contains the PH information item of the PCell to which the UE 10 is primarily connected and the PH information item(s) of SCell(s) with configured uplinks.

If there is a SCell that is in the process of activation (YES in S103), it is further determined whether a predetermined time period has passed since the PHR was triggered (S105). If the predetermined time period has not expired yet (NO in S105), then PHR is suspended from being sent (S107). If the predetermined time period has passed since the PHR was triggered (YES in S105), PHR is sent (S106). This PHR may contain the PH information item of the PCell, the PH information item(s) of other SCell(s) with configured uplinks, and the PH information item of the activated SCell #1.

Upon finishing the process of the current TTI, the same process is repeated for the next TTI.

### SECOND EMBODIMENT

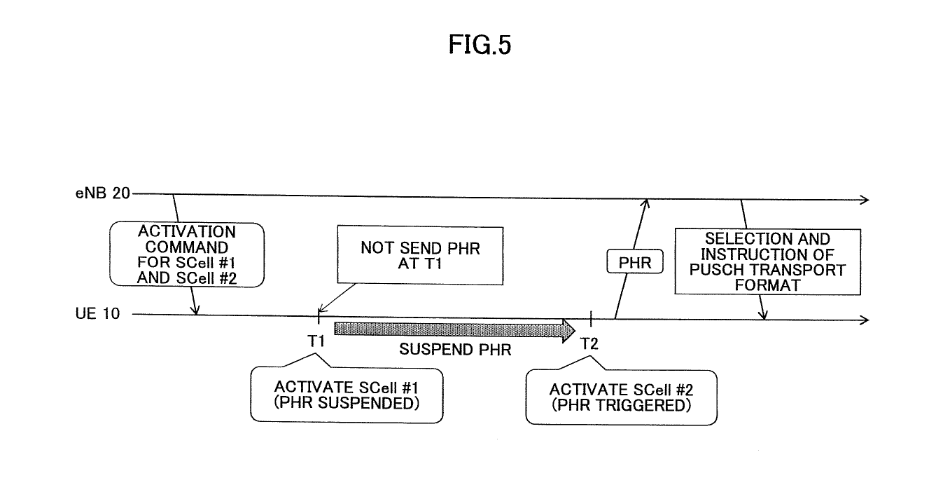

FIG. 5 illustrates PHR transmission timing control according to the second embodiment. The process of FIG. 5 represents a scenario where a PHR is triggered by activation of a SCell, namely, where the above-described condition (d) is satisfied.

Upon receiving an activation command for SCell #1 and SCell #2 from the eNB 20, the UE 10 starts activating the SCell #1 and the SCell #2. At time T1, the activation of the SCell #1 is completed first, and PHR is triggered. However, since the SCell #2 is still in the process of activation at T1, a PHR is not sent at this point of time. When the SCell #2 becomes in the active state at time T2 when or before a predetermined time period passes from T1, then a PHR that contains a PH information item of the PCell and PH information items of the SCell #1 and the SCell #2 is sent.

If the activation of SCell #2 has not been completed at a time when the predetermined time period passes from T1, then a PHR that contains the PH information items of only the PCell and the SCell #1 is sent. After that, upon completion of activation of the SCell #2, a PHR that contains the PH information items of the PCell, the SCell #1 and the SCell #2 is sent again. In this case, it may not appear that overhead is reduced. However, because PHR triggering by activation commands is only a small part of the entire PHR triggering events, uplink overhead can be reduced sufficiently as a whole.

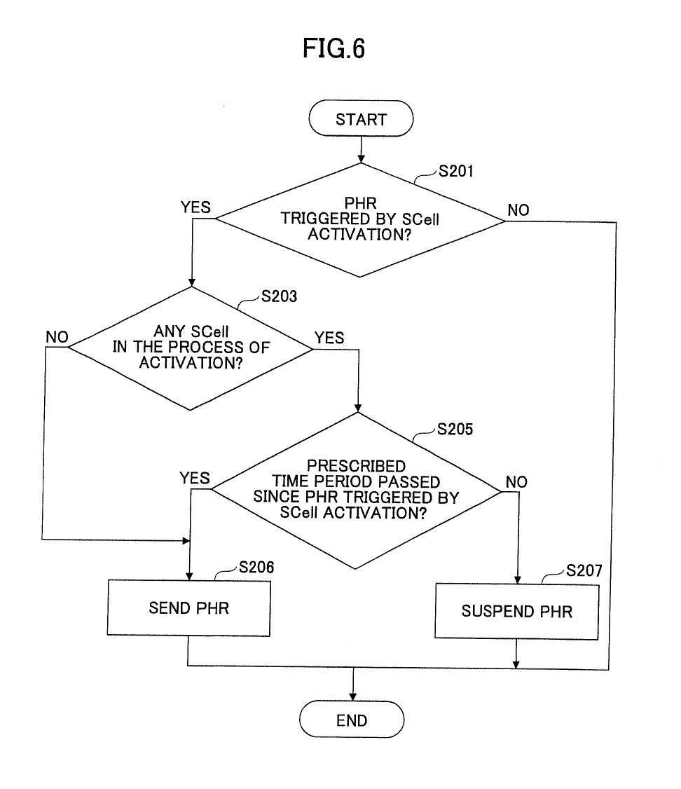

FIG. 6 is a flowchart of PHR transmission timing control performed at the UE 10 according to the second embodiment.

It is determined at UE 10 whether PHR triggering has occurred by activation of the SCell (S201). If a PHR has been triggered by, for example, activation of te SCell #1 (YES in S201), it is determined whether there are any SCells that are in the process of activation (S203). If there is no SCell in the process of activation (NO in S203), a PHR is sent in an ordinary process (S206). If there is a SCell (e.g., Scell #2) that is in the process of activation (YES in S203), then it is further determined whether a predetermined time period has passed since the PHR was triggered by the activation of the SCell #1 (S205). If the predetermined time period has not passed (NO in S205), the PHR is suspended from being sent (S207). If the predetermined time period has passed (YES in S205), a PHR is sent (S206).

If the activation of SCell #2 has been completed at expiration of the predetermined time period, a PHR that contains the PH information items of the PCell, the PHR trigger inducing SCell #1, and the completely activated SCell #2 is sent to the eNB 20. If the activation of SCell #2 has not been completed at expiration of the predetermined time period, then a PHR that contains the PH information items of the PCell and the PHR trigger inducing SCell #1 is sent.

### <Structure of UE>

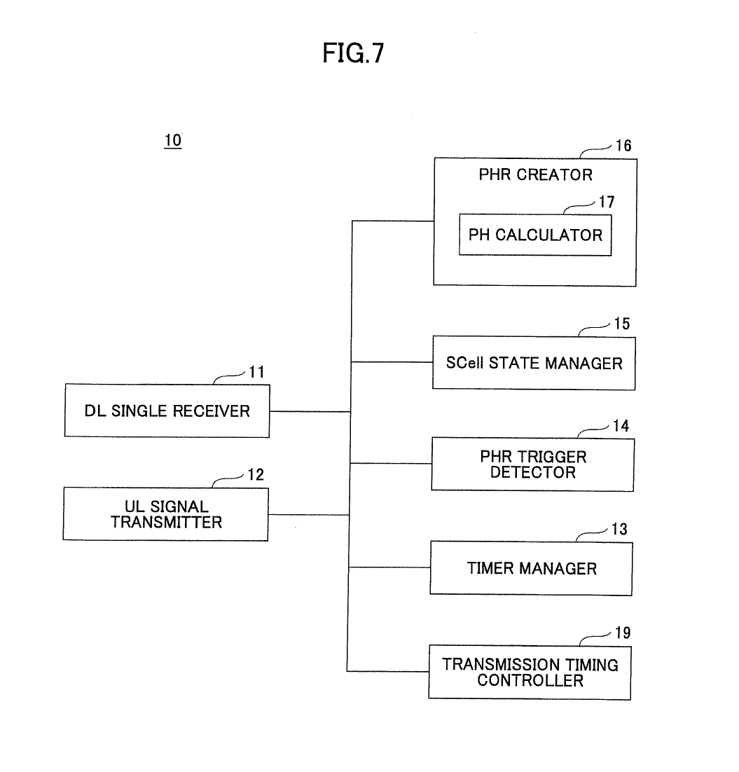

FIG. 7 is a schematic diagram of the UE 10. The UE 10 has a downlink (DL) signal receiver 11, an uplink signal transmitter 12, a timer manager 13, a PHR trigger detector 14, a secondary cell (SCell) state manager 15, a PHR creator 16, and a transmission timing controller 19. The PHR creator 16 has a power headroom (PH) calculator 17.

The DL signal receiver 11 receives downlink signals in the designated frequency band or, if carrier aggregation is performed, on the allocated component carriers. The UL signal transmitter 12 transmits uplink signals on the allocated frequency band or aggregated component carriers.

If the received signals are data signals (including control data), these data signals are demodulated and decoded at a signal processor (not illustrated) in an ordinary process. If the received signal is an activation command for a SCell configured at the UE 10, this command is interpreted at the MAC layer and the deactivated SCell is activated.

The PHR trigger detector 14 monitors and determines whether a PHR triggering event has occurred at the UE 10. Activation of a SCell is one of the PHR triggering events as described above, and there are many PHR triggering events occurring, for example, when the above-described conditions (a), (b), (C), and (e) are satisfied.

The SCell state manager 15 manages the activation state for each SCell configured at the UE 10. In the deactivated state, a SCell is not used for mobile communications, but is capable of battery energy savings. Upon activation of the SCell, a PHR is triggered and reception of a PDCCH and transmission of channel state information (CSI) and reference signals becomes available in that SCell.

The SCell state manager 15 determines whether there are any SCells that are in the process of activation upon detection of a PHR triggering event. If there is a SCell in the process of activation, the timer manager 13 starts a timer and counts a predetermined time period. Upon the start of the timer, the transmission timing controller 19 suspends the PHR due to the PHR triggering from being sent to the eNB 20.

If the activation of the SCell is completed before the timer managed by the timer manager 13 expires, the transmission timing controller 19 allows the PHR created by the PHR creator 16 to be transmitted from the UL signal transmitter 12.

The PH calculator 17 of the PHR creator 16 calculates the power headroom of the component carrier allocated to the activated SCell. The PHR creator 17 creates a PHR using the calculated power headroom. The created PHR is sent from the UL signal transmitter 12 under the above-explained PHR transmission timing control.

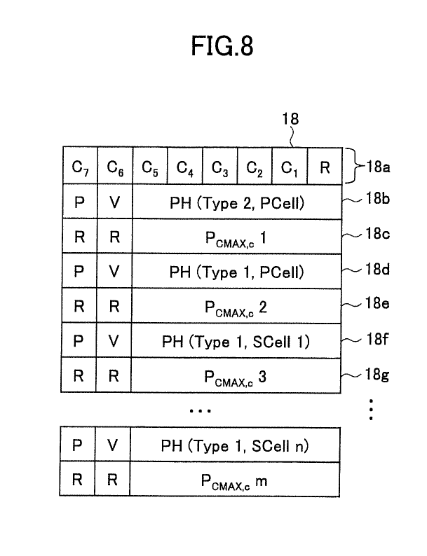

FIG. 8 illustrates an exemplified PHR format 18 created by the UE 10. The Cᵢ field 18a indicates for which cell the report is made in this PHR. For example, if the PHR includes PH information items of SCell #1 and SCell #2, C₁ and C₂ take a value “1” and the other SCells take a value “0”.

The PH fields 18b, 18d, 18f, and so on indicate PH values, together with the type of cell (PCell or SCell) and the report type (Type 1 or Type 2). P_{CMAX} fields 18c, 18e, 18g, and so on indicate the maximum transmit power levels of the UE 10. If power back-off is taken into account, the P field is set to, for example, a value “1”. The R field indicates a reservation bit. The V field indicates if the PH value is calculated based upon real transmission or a reference format.

With the structure illustrated in FIG. 7, the UE 10 manages the activation/deactivation states of the configured SCells and autonomously controls the PHR transmission timing without receiving transmission control information from the eNB 20. Accordingly, uplink overhead due to an excessive amount of PHR transmission can be reduced.

This patent application is based upon and claims the benefit of the priority of Japanese Patent Application No. 2013-113386 filed May 29, 2013, which is incorporated herein by reference in its entirety.

What is claimed is:

1. A radio communication system comprising:
a radio base station; and
a mobile terminal device communicating with the radio base station using carrier aggregation,
wherein upon occurrence of a triggering event of sending a power headroom report to the radio base station, the mobile terminal device is configured to determine whether there is a secondary cell that is in the process of activation, and
wherein the mobile terminal device is configured to suspend transmission of the power headroom report to the base station for a predetermined time period if there is a secondary cell that is in the process of activation.

2. The radio communication system according to claim 1,
wherein if the activation of the secondary cell is completed before expiration of the predetermined time period, then the mobile terminal device is configured to include a power headroom value of the secondary cell in the power headroom report and transmit the power headroom report to the radio base station.

3. The radio communication system according to claim 2,
wherein if the secondary cell that is in the process of activation has not been completely activated at the expiration of the predetermined time period, the mobile terminal device is configured to transmit the power headroom report without including the power headroom value of the secondary cell.

4. The radio communication system according to claim 1,
wherein the triggering event is activation of a first secondary cell, and
wherein if activation of a second secondary cell that was in the process activation at the time of the activation of the first secondary cell is completed before expiration of the predetermined time period, the mobile terminal device is configured to include a power headroom value of a primary cell to which the mobile terminal device is primarily connected and power headroom values of the first and second secondary cells in the power headroom report and transmit the power headroom report to the radio base station.

5. The radio communication system according to claim 4,
Wherein if the activation of the second secondary cell has not been completed before the expiration of the predetermined time period, the mobile terminal device is configured to transmit the power headroom report to the radio base station upon expiration of the predetermined time period, without including the power headroom value of the second secondary cell.

6. A mobile terminal device comprising:
a trigger event detector configured to monitor whether transmission of a power headroom report has been triggered;
a PHR creator configured to create a power headroom report upon detection of triggering of the power headroom report;
a secondary cell state manager configured to determine whether there is a secondary cell that is in the process of activation when the power headroom report is triggered; and
a transmission timing controller configured to suspend transmission of the power headroom report if there is a secondary cell that is in the process of activation at the time of the triggering of the power headroom report.

7. The mobile terminal device according to claim 6,
wherein if the activation of the secondary cell is completed before expiration of the predetermined time period, then the mobile terminal device is configured to includes a power headroom value of the secondary cell in the power headroom report and transmit the power headroom report to the radio base station.

8. The mobile terminal device according to claim 7,
wherein if the secondary cell that is in the process of activation has not been completely activated at the expiration of the predetermined time period, the mobile terminal device is configured to transmit the power headroom report without including the power headroom value of the secondary cell.

9. The mobile terminal device according to claim 6,
wherein the triggering event detector is configured to detect activation of the first secondary cell as a power headroom report triggering event;
wherein if activation of a second secondary cell that was in the process activation at the time of the activation of the first secondary cell is completed before expiration of the predetermined time period, the mobile terminal device is configured to include a power headroom value of a primary cell to which the mobile terminal device is primarily connected and power headroom values of the first and second secondary cells in the power headroom report and transmit the power headroom report to the radio base station.

10. The mobile terminal device according to claim 9,
Wherein if the activation of the second secondary cell has not been completed before the expiration of the predetermined time period, the mobile terminal device is configured to transmit the power headroom report to the radio base station upon expiration of the predetermined time period, without including the power headroom value of the second secondary cell.
